(19) United States
(12) Patent Application Publication
(10) Pub. No.: US 2026/0140274 A1
(43) Pub. Date: May 21, 2026

(54) Universal Inspection Process

(71) Applicants: Alessandro Manneschi, Arezzo (IT); Luca Manneschi, Arezzo (IT)

(72) Inventors: Alessandro Manneschi, Arezzo (IT); Luca Manneschi, Arezzo (IT)

(21) Appl. No.: 19/042,399

(22) Filed: Jan. 31, 2025

(30) Foreign Application Priority Data
Nov. 19, 2024 (FR) FR2412624

(51) Int. Cl. G01V 3/10; G01S 13/89; G01V 5/22

(52) U.S. Cl. CPC G01V 3/10; G01S 13/89; G01V 5/22

(57) ABSTRACT

A method of inspection of an individual by means of a dual-technology detection system comprising:
the inspection of the individual according to a first operating mode and a second operating mode when the individual belongs to a first category;
the inspection of the individual according to the first operating or the second operating mode when the individual belongs to a second category; and
the inspection of the individual according to a third operating mode when the individual belongs to a third category.

### TECHNICAL FIELD

This disclosure relates to the field of detectors designed for the detection of unauthorized objects or materials in a protected-access area. More precisely, this disclosure relates to a detection system designed to inspect individuals at the entrance or exit of a sensitive area, for example passengers before boarding in airports, in order to detect prohibited objects hidden under clothing. Such systems in particular make it possible avoid systematic hand searching.

### BACKGROUND

At the present time it appears necessary to monitor with a high degree of reliability any attempt to bring prohibited products, particularly weapons, into or out of a sensitive area.

The problem encompasses a very wide range of situations, in particular, without limitation, the attempt to bring prohibited products into a protected area, such as an airport.

Different types of detectors of metal objects exist. Generally metal detectors are detectors of inductive type. They comprise at least one transmitter coil and at least one receiver coil. The transmitter coil is supplied with an AC electric current. The receiver coil is designed to detect disturbances in the magnetic field generated by the transmitter coil due to the presence of a metallic object, for example the attenuation of the amplitude of the magnetic field, or even the change of phase of the signal, due for example to the eddy currents generated on the metallic object.

Provision has also been made for using body scanners to detect weapons, explosives etc. hidden under the clothing of individuals entering a protected area. These scanners use technologies based on the detection of modulated radiation energies, reflected or emitted by the body of the inspected individuals. The radiation energies thus used comprise X rays, microwaves (particularly millimeter waves), infrared light, terahertz waves and ultrasounds. These body scanners all have the principle of the creation of an electronic image of the individual on which the clothing of the individual is transparent. This image is then displayed on a screen and viewed by an operator so that he can determine whether or not the individual is bearing a target object. To do so, the operator, who is trained in the detection of target objects, must be capable of determining whether or not the objects identified by the body scanner correspond to the human anatomy, to an authorized object such as a lighter, a handkerchief or coins, or to a target object such as a weapon or an explosive. In a variant, in order to respect the privacy of the inspected persons, the detection system 1 may comprise a software program comprising code instructions for automatically analyzing the image and determining the presence of any anomalies and displaying them on an avatar 23 representing the person.

Certain protected areas, particularly airports, require their passengers to remove part of their clothing and accessories (particularly their shoes, their coat, their headgear, their watch, their liquid products etc.) in order to inspect them separately in an X-ray scanner or equivalent. Specifically, this procedure makes it possible to increase the sensitivity of the detection system used for the inspection of the passengers, without however risking the generation of alarms due to the presence of metallic or non-metallic objects which are in fact authorized in the protected area. However, this procedure has the consequence of greatly slowing down the inspection of the passengers, given the time needed to take off clothing. Certain airports have therefore decided to simplify the inspection of a portion of the passengers, when they meet particular conditions and are pre-registered. In particular, for these pre-registered passengers, these airports create special inspection areas in which it is not necessary to remove clothing and accessories. The detection typology of the detection systems is then modified in these special inspection areas in order to allow the passage of objects such as watches, belts or shoes which would otherwise have triggered an alarm in a standard detection system. The speed of inspection of these pre-registered passengers is therefore higher since they can be inspected directly without taking off their clothing, while the standard inspection areas are less crowded.

Similarly, certain passengers are simply unable to undergo a standard or modified inspection (for pre-registered passengers), either in a detector of inductive type or of body scanner type, particularly when they have to travel in a wheelchair or bear electronic life support devices. These passengers must then bypass the detectors and undergo a manual search.

Thus, these three types of passengers are inspected by different inspection means. However, certain protected areas do not possess sufficient space to accommodate different detection areas, or has a limited number of flights per day not justifying multiple different teams of security officers.

### SUMMARY

One aim of the summary is to make provision for a solution for allowing detection adapted to the individuals who are to be inspected, of modest overall dimensions to allow for its application in limited spaces, and which can be implemented by a limited number of operators (security officers).

For this purpose provision is made, according to a first aspect, for a method of inspection of an individual belonging to a first or a second or a third category by means of a dual-technology detection system configured to operate according to a first operating mode, a second operating mode or a third operating mode, in which:
the first operating mode comprises the implementation of a first detection technology for the detection of a target object;
the second operating mode comprises the implementation of a second detection technology distinct from the first detection technology for the detection of a target object; and
the third operating mode comprises the absence of detection by means of the first and the second technology.

The method of inspection comprises:
a step of inspection of the individual by means of the detection system operating according to the first operating mode and the second operating mode when the individual belongs to the first category; and
a step of inspection of the individual by means of the detection system operating according to the first operating or the second operating mode when the individual belongs to the second category; and
a step of inspection of the individual by means of the detection system operating according to the third operating mode when the individual belongs to the third category.

Certain preferred but non-limiting features of the method of inspection according to the first aspect are as follows, taken individually or in combination
the first operating mode comprises the generation of a magnetic field, the acquisition of electrical signals representative of the magnetic field and the analysis of the electrical signals for detecting the presence of a metallic object;
the second operating mode comprises the transmission of a radiant energy such as to produce an electronic image
the third operating mode comprises the absence of generation of a magnetic field and of transmission of radiant energy;
when the individual belongs to the second category, the detection system operates according to the first operating mode;
the method of inspection further comprises a prior step of classification of the individual from among one of the three categories;
the classification step is performed by an operator;
the classification step is performed automatically by reading a code of data readable by a machine;
the individuals belonging to the second category are pre-registered, the method of inspection comprising a prior step of registering characteristics of these individuals;
the method of inspection further comprises a step of manual inspection by an operator when the detection system is operating according to the third operating mode; and/or
the first operating mode is executed as default.

According to a second aspect, provision is made for a dual-technology detection system configured to operate according to a first operating mode, a second operating mode or a third operating mode, the detection system comprising:
a gate comprising two lateral panels configured to define a passageway;
first detection means housed in the lateral panels and configured to execute a first operating mode of the detection system;
second detection means distinct from the first detection means, housed in the lateral panels and configured to execute a second operating mode of the detection system; and
a processing unit configured to:
send instructions to the first and second detection means such as to execute the first and the second operating mode;
send instructions to the first or the second detection means such as to execute the first or the second operating mode;
execute the third operating mode by disabling the first and second detection means, and
when the first and/or second detection means detect a target object, send instructions for generating an alert.

Certain preferred but non-limiting features of the detection system according to the second aspect are as follows, taken individually or in combination:
the first detection means comprise an inductive metal detector comprising a transmitter assembly configured to transmit a magnetic field, a receiver assembly configured to generate electrical signals representative of disturbances of the magnetic field by a metallic object, and a central unit configured to deduce therefrom the presence of a metallic object;
the second detection means comprise a body scanner comprising at least one transmitter antenna configured to transmit a radiant energy, at least one receiver antenna configured to receive a reflected energy and a central unit configured to deduce therefrom an electronic image of the individual;
the detection system further comprises a selector configured to select at least one from among the first, the second and the third operating mode; and/or
wherein the processing unit is furthermore configured to generate an avatar and represent on this avatar the result of the execution of the first and/or of the second operating mode.

### DESCRIPTION OF THE FIGURES

Other features, aims and advantages of the invention will become apparent from the following description, which is purely illustrative and non-limiting, and which must be read with reference to the appended drawings on which:

FIG. 1 is a perspective view of an example of a detection system in accordance with an embodiment;

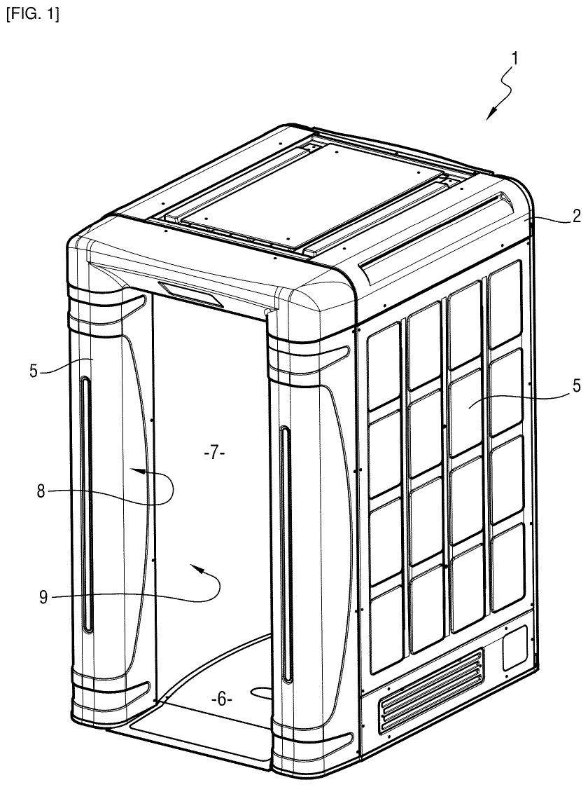

FIG. 2 is a schematic and section view of the example of a detection system of FIG. 1;

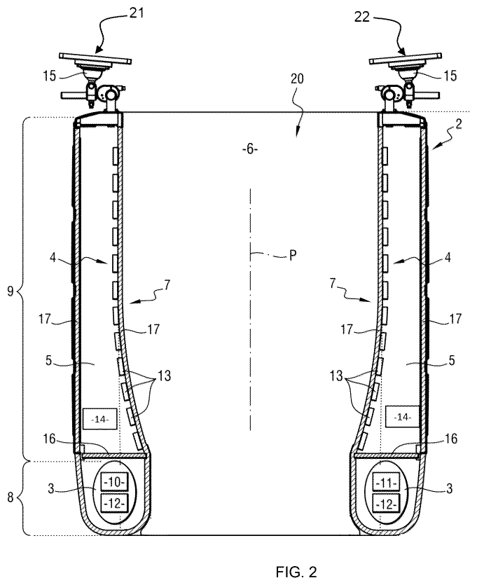

FIG. 3 is a schematic view of an exemplary embodiment of a screen which can be implemented in a detection system in accordance with an embodiment; and

FIG. 4 is a block diagram comprising steps of a method of inspection in accordance with an embodiment.

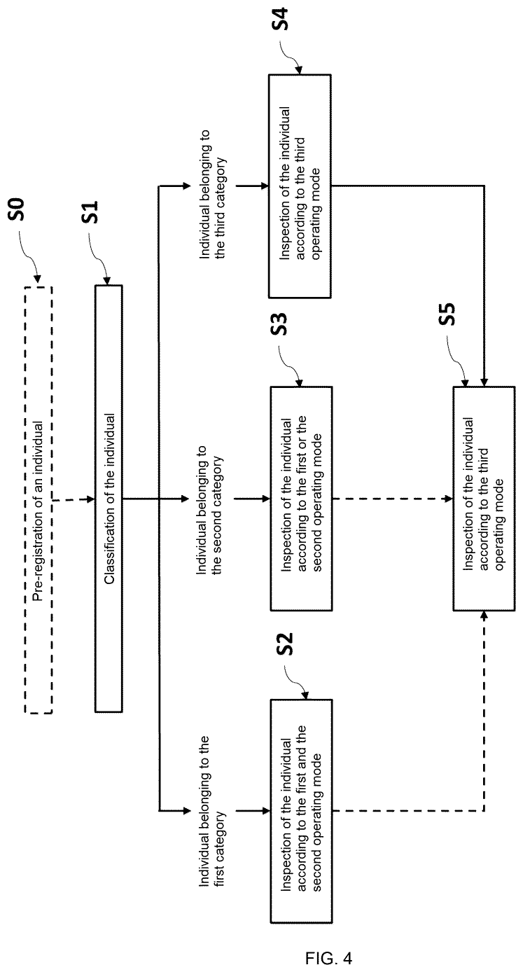

On all the figures, similar elements bear identical reference numbers.

### DETAILED DESCRIPTION

To allow the adapted detection of individuals in a space of small overall dimensions, manageable by a single security officer, this summary makes provision for a method of inspection using a dual-technology detector, in which the detection means 3, 4 are selectively enabled according to the type of individual to be inspected.

In the remainder of the text, the detection system 1 and the method of inspection will be described in the case of a dual-technology detection system 1 comprising detection means of inductive type 3 and a body scanner comprising microwave antennas. This is however non-limiting, all detection means being able to be implemented in the context of this summary, including, without limitation, X-rays, infrared light, terahertz waves or ultrasounds.

The dual-technology detection system 1 comprises for this an integrated gate 2 in which are housed a continuous-or pulsed-wave inductive metal detector 3 and a body scanner 4. The inductive metal detector 3 and the body scanner 4 are therefore both integrated into one and the same structure, which makes it possible to reduce the overall dimensions of the system 1. In addition, by integrating the inductive metal detector 3 and the body scanner 4 into one and the same gate 2, the inductive metal detector 3 and the body scanner 4 are monolithic with one another, thus eliminating any risk of relative motion between these two devices which greatly improves the stability of the detection system 1 and their electromagnetic compatibility.

The gate 2 comprises lateral panels 5 which are substantially identical with respect to a plane P and configured to define between one another a passageway 6 for an inspected person. The lateral panels 5 may be mechanically connected by a ceiling and/or a platform 20 such as to form a single part or be separate and distinct.

Each panel 5 has an inner face 7, oriented toward the passageway 6 and together delimiting an entrance of the passageway 6 at a first end of the panels 5 and an exit at the level of an opposite end.

The panels 5 successively comprise a first portion 8 which houses the inductive metal detector 3 and a second portion 9 which houses the body scanner 4. In an embodiment, the first portion 8 is disposed on the side of the inlet of the passageway 6 while the second portion extends between the first portion and the outlet of the passageway 6.

In an embodiment, the inner faces 7 of the panels 5 are substantially planar and parallel to one another. In a variant, the inner faces 7 of the panels 5 can be planar and parallel in the first portion 9 and curved in the second portion 10, as detailed in the document WO 2021/099217. This is however only a non-limiting embodiment.

### The Inductive Metal Detector 3

In a manner known per se, the inductive metal detector 3 comprises a transmitter assembly 10 and a receiver assembly 11. The transmitter assembly 10 comprises at least one transmitter coil housed in the first panel 5 and configured to transmit a magnetic field. The receiver assembly 11 comprises at least one receiver coil housed in the second panel 5 which is configured to detect disturbances in the magnetic field due to metallic objects. Finally, the system 1 comprises analysis means 12 configured to analyze the signals coming from the receiver coils 11 to detect the presence of metallic objects borne by an individual passing through the passageway 6 formed between the two lateral panels 5.

In an embodiment, the transmitter 10 and receiver 11 coils cover the entire height of the lateral panels 5. They may be the subject of many known embodiments, as are currently in use in conventional gates for the detection of metals. Their operation is also conventional in itself. The structure and operation of the transmitter 10 and receiver 11 coils will therefore not be described in detail in the remainder of the text. It will however be noted that each transmitter 10 or receiver 11 coil can be formed by several separate windings, the relative distribution of which over the height of the lateral panels 5 is suitable for optimizing detection and is controlled by the analysis means 12, where applicable by way of a transmitter and receiver interface, to transmit alternating inductive fields over a range of frequencies and receive all these alternating inductive fields over said frequency range, respectively.

In an embodiment, the inductive metal detector fields generated by the transmitter 10 and receiver 11 coils are in the frequency range between 70 Hz and 50 kHz, preferably between 100 Hz and 50 KHz.

To avoid the electromagnetic interference that can be generated by the body scanner 4, the system 1 can moreover comprise a shielding 16 positioned between the inductive metal detector 3 and the body scanner 4.

One may refer to the dual-technology detection system described in the document WO 2021/099217 for more details about the inductive metal detector 3, and particularly the shielding 16 and the configuration of the coils 10, 11.

### The Body Scanner 4

The body scanner 4 comprises at least one antenna 13 configured to transmit a radiant energy, preferably microwaves such as millimeter waves, X-rays, terahertz waves etc. In an embodiment, the body scanner 4 comprises an array of antennas 13 positioned in at least one of the panels 5, preferably each panel 5, in proximity to its inner face 7. The array of antennas 13 therefore substantially follows the shape of the associated inner face 7.

In an embodiment, the antennas 13 transmit millimeter waves. Millimeter waves are suitable for the detection of metallic and non-metallic objects, such as for example ceramic objects. Furthermore, air and other materials, such as those used for clothing, are transparent to this radiation. As a result millimeter waves can be used for the detection of objects hidden under clothing. In use, an inspected person is exposed to pulses of millimeter waves generated by at least one of the antennas 13, preferably several antennas 13. These waves interact with the body of the person, his clothing and any objects masked or where applicable hidden by this person under his clothing. This interaction modulates the energy of the waves which, once reflected, return onto the antenna or antennas 13, which serve as receiver. The energy reflected by each part of the person is then analyzed in order to generate an electronic image of the inspected person, on which his clothing are basically transparent.

The system 1 moreover comprises analysis means 14 configured to receive a signal representative of the energy reflected and measured by the antennas 13, where applicable by way of an array interface, and deduce therefrom the electronic image.

In an embodiment, the detection system 1 further comprises at least one processing unit 15 configured to exploit the detection signals generated by the inductive metal detector 3 and by the body scanner 4. Where applicable, the processing unit 15 comprises the analysis means 12 of the inductive metal detector 3 and the analysis means 14 of the body scanner 4 and is configured to generate a single image as output based on signals generated by the inductive metal detector 3 and on the electronic image created by the body scanner 4. Where applicable, the system 1 further comprises at least one screen 21, 22, configured to display the single image thus obtained. The screen 21, 22 can be mounted on the gate 2, for example at the exit end of one of the lateral panels 5, or in a variant placed at a distance and communicate via a wireless or wired interface with the processing unit 15.

In a first exemplary embodiment, the system 1 for example comprises a first processing unit 15 associated with a first screen configured to generate a single image as output based on signals generated by the inductive metal detector 3 and on the electronic image created by the body scanner 4 of one of the panels 5, and a second processing unit 15 associated with a second screen configured to generate a single image as output based on signals generated by the inductive metal detector 3 and on the electronic image created by the body scanner 4 of the other of the panels 5. In a variant, one and the same processing unit 15 can be configured to generate both electronic images.

In an embodiment, the coils of the transmitter assembly 10 and of the receiver assembly 11 of the inductive metal detector 3 and the antennas 13 of the body scanner 4 can be rigidly attached to one and the same base 17 in each panel 5. One may refer to the dual-technology detection system described in the document WO 2021/099217 for more details about the configuration of these bases 17.

In a manner known per se, the system 1 further comprises a supply and interface unit UAI connected to the electrical network and, where applicable, to a communication network.

### The Method of Inspection

As indicated above, the method of inspection implements the detection means selectively according to the type of individual to be inspected. To do so, the detection system 1 has three operating modes, namely:
a first operating mode corresponding to an inspection by first detection means, here the inductive metal detector 3;
a second operating mode corresponds to an inspection by second detection means, here the body scanner 4; and
a third operating mode corresponds to the absence of inspection by these detection means, here by the inductive metal detector 3 and the body scanner 4.

To do so, the individual to be inspected is classified into one from among at least three categories (step S1). Note that the individual can belong to only one of these three categories. In an exemplary embodiment, the first category corresponds to individuals who are to undergo a standard inspection. These are therefore the majority of individuals who are to be inspected.

The second category may comprise pre-registered individuals. Pre-registered individuals are individuals who have supplied ahead of time a list of predetermined information (such as information relating to their identity) and/or meet a list of predetermined conditions (such as nationality, professional activity etc.) and have completed a pre-registration procedure with a competent organization. An example of pre-registration of an individual can be for example be the “PreCheck®” system offered by the TSA (Transportation Security Administration) in the United States.

The third category may comprise mobility-impaired individuals, for example wheelchair users, or individuals bearing electronic devices, such as a pacemaker or any device at risk of being damaged in a magnetic field or a microwave field.

The classification of the individual (step S1) can be done manually, for example by an operator. Specifically, an operator can easily determine whether or not an individual belongs to the second or the third category on presentation by the individual of appropriate supporting documentation (certificate of pre-registration or special travel ticket for the second category, medical documentation for the third category). In the absence of appropriate supporting documentation, the operator may automatically classify the individual as being in the first category.

In a variant, the information relating to the category of the individual can be incorporated into a code readable by a machine (of QR code or bar code type) and/or be incorporated into his travel ticket, so that a simple electronic check of the code or of the ticket makes it possible to determine the category of the individual. The classification step S1 is then automatic.

The way in which the individual will be inspected then depends on the category to which the individual belongs. The method of inspection can in particular:
inspect the individual by means of the detection system 1 operating according to the first operating mode and the second operating mode when the individual belongs to the first category (step S2);
inspect the individual by means of the detection system 1 operating according to the first operating or the second operating mode when the individual belongs to the second category (step S3); and/or
inspect the individual by means of the detection system 1 operating according to the third operating mode when the individual belongs to the third category (step S4).

More precisely, when the individual belongs to the first category, the method of inspection implemented is standard. To do this, the operator initiates a standard inspection sequence in order to trigger the first and the second operating mode of the detection system 1, for example by pressing on a dedicated mechanical button of the detection system 1 or on a dedicated area 21a of the screen 21 corresponding to this inspection sequence. In a variant, the standard inspection sequence can be initiated automatically by the processing unit 15, particularly when the classification step is done automatically. According to yet another variant, the first operating mode of the detection system 1 is executed as default by the processing unit 15.

During this standard inspection sequence, the individual passes through the passageway 6 of the gate and undergoes an inspection by the inductive metal detector 3 (first operating mode) and an inspection by the body scanner 4 (second operating mode), in order to guarantee the detection of any target object, whatever the type of object (metallic, dielectric), its volume or its position (on the surface of the individual or in body cavities). Preferably, the detection system 1 first comprises the inductive metal detector 3, at the entrance to the passage, then the body scanner 4, so that the individual enters the passageway 6, passing between the coils 10, 11, then comes into position facing one of the inner walls 7 of the lateral panels 5, facing the microwave antennas 13. This is because it is preferable for the individual to be in the static position during the transmission of the microwaves in order to generate a clearer electronic image. Contrariwise, since the detection done by the inductive metal detector 3 is based on the variation in the magnetic field, it is not necessary for the individual to stop in front of the coils 10, 11.

During the standard inspection sequence, the processing unit 15 thus enables the coils 10, 11 in order to generate a magnetic field and detect the presence of a metallic object on entry of the individual into the passageway 6, as well as the microwave antennas 13 in order to produce an electronic image.

In an embodiment, the processing unit 15 sends instructions to the inductive metal detector 3 to generate a magnetic field as soon as the standard inspection sequence is initiated (by the operator or automatically), or as soon as the presence of the individual in the passageway 6 is detected (typically, using optical barriers forming presence detectors). When the first operating mode (inductive metal detection) is executed as default, the magnetic field is generated as soon as the individual is detected in the passing passageway 6.

Optionally, during the inspection by the inductive metal detector 3, the antennas 13 can be disabled, to avoid transmitting microwaves during the acquisition of the electrical signals by the coils 10, 11.

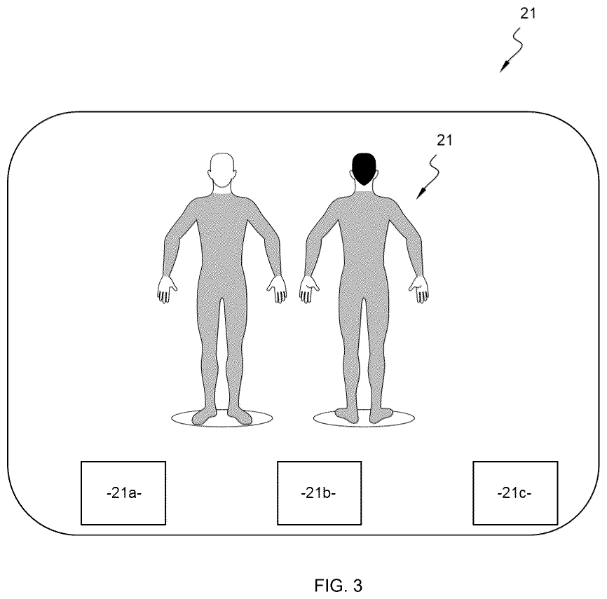

After the inspection by the inductive metal detector 3, the processing unit 15 sends instructions to the body scanner 4 to produce an electronic image of the individual. Optionally, during the transmission of the microwaves by the antennas 13, the coils 10, 11 may be disabled. The inspection by the body scanner 4 can be done automatically after the detection by the inductive metal detector 3 (or after a predetermined time period after the initiation of the standard inspection sequence), or on activation of the second operating mode by the operator. For example, the operator can wait for the person to be positioned correctly with respect to the panels 5 (typically facing the lateral panels 5) to trigger the second operating mode, particularly using the dedicated button of the detection system or by pressing on a dedicated area 21b of the screen 21.

Where applicable, the processing unit 15 can generate an avatar 23 as illustrated on FIG. 3) and represent on this avatar 23 both the result of the analysis of the signals generated by the coils of the metal detector and the electronic image obtained using the antennas of the body scanner.

When the processing unit 15 detects a target object (either using the signals generated by the coils or the antennas) it sends instructions to generate an alert to an alarm. For example, the area in which a target object has been detected by the inductive metal detector 3 can be highlighted in relation to the rest of the body (for example by coloring only the corresponding part of the avatar 23 in red). Moreover, the shape of the target object detected by the body scanner 4 can be represented on the avatar. If the inductive metal detector 3 (and, where applicable, the body scanner 4) does not detect any object, the avatar 23 can moreover be colored uniformly in green (as illustrated for example on FIG. 3).

In the event of detection by the detection system 1, the individual can then be inspected manually by an operator (step S5).

When the individual belongs to the second category, the processing unit 15 executes a simplified inspection sequence. To do this, the first operating mode or the second operating mode of the detection system 1 is triggered by the operator (by pressing on a second dedicated mechanical button of the detection system 1 or on a second dedicated area 21b of the screen 21 corresponding to this inspection sequence) or automatically by the processing unit 15, in particular when the classification step is done automatically.

In an embodiment, the simplified inspection sequence implements the first detection mode, i.e. the inspection by the inductive metal detector 3. This is because this detection mode is faster, since it does not require the individual to remain static between the lateral panels 5, and is very effective for the detection of metallic objects.

During the simplified inspection sequence, the processing unit 15 therefore enables the coils 10, 11 in order to generate a magnetic field and detect the presence of a metallic object on entry of the individual into the passageway. However, the processing unit 15 does not enable the microwave antennas 13 and does not produce any electronic image.

In an embodiment, the processing unit 15 sends instructions to the inductive metal detector 3 in order to generate a magnetic field as soon as the simplified inspection sequence is initiated (by the operator or automatically) or as soon as the presence of the individual in the passageway is detected (typically, using optical barriers forming presence detectors). When the first detection mode is executed as default, the simplified inspection sequence can be initiated as soon as the individual is detected in the passageway 6.

In an embodiment, the sensitivity of the inductive metal detector 3 can be reduced during the simplified inspection sequence, in order to limit untimely alarms able to be generated due to the wearing of a belt, shoes etc. It is specifically recalled that individuals belonging to the second category can be pre-registered and be permitted not to take off their clothing, unlike individuals belonging to the first category.

Where applicable, the processing unit 15 can generate an avatar 23 and represent on this avatar 23 the result of the analysis of the signals generated by the coils of the inductive metal detector 3 (or where applicable, the antennas 13 of the body scanner 4, when the simplified inspection sequence implements the second detection mode only.) When the processing unit 15 detects a target object, it sends instructions to generate an alert to an alarm. For example, the area in which a target object has been detected by the inductive metal detector 3 can be highlighted in relation to the rest of the body (for example by coloring only the corresponding part of the avatar 23 in red). Here again, if the inductive metal detector 3 (and, where applicable the body scanner) does not detect any object, the avatar 23 can moreover be colored uniformly in green.

In the event of detection by the detection system 1, the individual can then be inspected manually by an operator (step S5).

When the individual belongs to the third category, the processing unit 15 executes a bypass sequence. To do this, the third operating mode is triggered by the operator (by pressing on a third dedicated mechanical button of the detection system 1 or on a third dedicated area 21c of the screen 21 corresponding to this bypass sequence) or automatically by the processing unit 15, particularly when the classification step is done automatically.

During the bypass sequence, the processing unit 15 disables the coils 10, 11 and the microwave antennas 13. The term “disable” will here be understood to mean that the coils 10, 11 do not generate any magnetic field and the antennas 13 do not transmit any radiant energy. Hence, the individual can cross the passage without risk (particularly when he is bearing an electronic device) and without triggering any alarm (particularly when he is supported by a metallic wheelchair). The individual can then be inspected manually by an operator (step S5).

1. A method of inspection of an individual belonging to a first or a second or a third category, the method of inspection comprising:
a step of inspection of the individual by means of a detection system operating according to a first operating mode and a second operating mode when the individual belongs to the first category, the first operating mode comprising the implementation of a first detection technology for detection of a target object and the second operating mode comprising the implementation of a second detection technology distinct from the first detection technology for detection of a target object;
a step of inspection of the individual by means of the detection system operating according to the first operating or the second operating mode when the individual belongs to the second category; and
a step of inspection of the individual by means of the detection system operating according to a third operating mode when the individual belongs to the third category, the third operating mode comprising an absence of detection by means of the first detection technology and the second detection technology.

2. The method of inspection as claimed in claim 1, wherein the first operating mode comprises a generation of a magnetic field, an acquisition of electrical signals representative of the magnetic field and an analysis of the electrical signals for detecting a presence of a metallic object.

3. The method of inspection as claimed in claim 1, wherein the second operating mode comprises a transmission of radiant energy such as to produce an electronic image.

4. The method of inspection as claimed in claim 3, wherein the first operating mode comprises a generation of a magnetic field, an acquisition of electrical signals representative of the magnetic field and an analysis of the electrical signals for detecting a presence of a metallic object and the third operating mode comprises an absence of generation of a magnetic field and of transmission of radiant energy.

5. The method of inspection as claimed in claim 1, wherein, when the individual belongs to the second category, the detection system operates according to the first operating mode.

6. The method of inspection as claimed in claim 1, further comprising a prior step of classification of the individual from among one of the three categories.

7. The method of inspection as claimed in claim 6, wherein the classification step is performed by an operator and/or automatically by reading a code of data readable by a machine.

8. The method of inspection as claimed in claim 1, wherein individuals belonging to the second category are pre-registered, the method of inspection comprising a prior step of registering characteristics of these individuals.

9. The method of inspection as claimed in claim 1, comprising a step of manual inspection by an operator when the detection system is operating according to the third operating mode.

10. The method of inspection as claimed in claim 1, wherein the first operating mode is executed as default.

11. A dual-technology detection system configured to operate according to a first operating mode, a second operating mode or a third operating mode, the detection system comprising:
a gate comprising two lateral panels configured to define a passageway therebetween;
first detection means housed in the lateral panels and configured to execute a first operating mode of the detection system;
second detection means distinct from the first detection means, housed in the lateral panels and configured to execute a second operating mode of the detection system; and
a processing unit configured to:
send instructions to the first and second detection means such as to execute the first and the second operating mode;
send instructions to the first or the second detection means such as to execute the first or the second operating mode;
execute the third operating mode by disabling the first and second detection means, and
when the first and/or second detection means detect a target object, send instructions for generating an alert to an alarm of the detection system.

12. The detection system as claimed in claim 11, wherein the first detection means comprise an inductive metal detector comprising a transmitter assembly configured to transmit a magnetic field, a receiver assembly configured to generate electrical signals representative of disturbances of the magnetic field by a metallic object, and a central unit configured to deduce therefrom a presence of a metallic object.

13. The detection system as claimed in claim 11, wherein the second detection means comprise a body scanner comprising at least one transmitter antenna configured to transmit a radiant energy, at least one receiver antenna configured to receive a reflected energy and a central unit configured to deduce therefrom an electronic image of the individual.

14. The detection system as claimed in claim 11, further comprising a selector configured to select at least one from among the first, the second and the third operating mode.

15. The detection system as claimed in claim 13, wherein the first detection means comprise an inductive metal detector comprising a transmitter assembly configured to transmit a magnetic field, a receiver assembly configured to generate electrical signals representative of disturbances of the magnetic field by a metallic object, and a central unit configured to deduce therefrom z presence of a metallic object, the processing unit being furthermore configured to generate an avatar and represent on this avatar an output resulting from operating the first and/or the second operating mode.

16. A method of inspection of an individual belonging to a first or a second or a third category, the method of inspection comprising:
a step of implementation of a first detection technology for detection of a target object and of a second detection technology distinct from the first detection technology for the detection of a target object when the individual belongs to the first category;
either a step of implementation of the first detection technology for detection of a target object, or a step of implementation of the second detection technology when the individual belongs to the second category; and
a step of inspection of the individual using neither the first detection technology nor the second detection technology.

17. The method of inspection as claimed in claim 16, wherein individuals belonging to the second category are pre-registered, the method of inspection comprising a prior step of registering characteristics of these individuals.

18. The method of inspection as claimed in claim 16, wherein the first operating mode comprises a generation of a magnetic field, an acquisition of electrical signals representative of the magnetic field and an analysis of the electrical signals for detecting the presence of a metallic object.

19. The method of inspection as claimed in claim 16, wherein the second operating mode comprises transmission of radiant energy such as to produce an electronic image.

20. The method of inspection as claimed in claim 19, wherein the first operating mode comprises a generation of a magnetic field, an acquisition of electrical signals representative of the magnetic field and an analysis of the electrical signals for detecting a presence of a metallic object and the third operating mode comprises an absence of generation of a magnetic field and of transmission of radiant energy.
